(19) United States
(12) Patent Application Publication
(10) Pub. No.: US 2008/0160057 A1
(43) Pub. Date: Jul. 3, 2008

(54) Antimicrobial Construction

(76) Inventor: Adrian Neville Fellows, Hebden Bridge (GB)

Correspondence Address: EGBERT LAW OFFICES, 412 MAIN STREET, 7TH FLOOR, HOUSTON, TX, 77002, US

(21) Appl. No.: 11/569,417

(22) PCT Filed: May 18, 2005
(86) PCT No.: PCT/GB2005/001878

§ 371 Date: Aug. 16, 2007

(30) Foreign Application Priority Data
May 21, 2004 (GB) 0411304.9

(51) Int. Cl. A01N 25/08

(52) U.S. Cl. 424/409

(57) ABSTRACT

A construction includes a substrate incorporating an activatable antimicrobial composition. The substrate includes a laminate having at least two layers bonded together by a thermoplastic bonding medium. The antimicrobial composition includes a peroxygen donor and an acid and/or an acid-producing substance. The peroxygen donor is incorporated separately and in a different portion of the substrate from the other component or components of the antimicrobial composition. Preferably, the antimicrobial composition includes a peroxygen donor in the form of sodium perborate as a mono or tetra hydrate, or sodium percarbonate and an acid-producing substance in the form of tetra acetyl ethylene diamine. Such an antimicrobial composition can be activated by wetting the substrate with water.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to a construction comprising a substrate incorporating an activatable antimicrobial composition for use, for example, as a pad, a wipe, or as a means of dosing the composition.

2. Description of Related Art Including Information Disclosed Under 37 CFR 1.97 and 37 CFR 1.98.

The term “substrate” used herein and in the claims is intended to include cloth, paper and other nonwoven materials as well as woven or knitted textile fabrics. In addition, the term “substrate” is intended to cover naturally occurring materials such as animal skins.

Antimicrobial compositions must exhibit a range of properties to be useful. Many of these properties are as follows.

1. The composition should act rapidly—European standards require a contact time of five minutes.

2. The composition should be biocidal and not merely biostatic.

3. The composition should have a wide spectrum of activity against bacteria, including all Gram-positive and Gram-negative bacteria, as well as mycobacteria.

4. The composition should be active against all types of fungi.

5. The composition should be virucidal, against both enveloped and non-enveloped viruses.

6. The composition should be effective in both clean and dirty conditions and be able to penetrate biofilms.

7. The composition should be rapidly effective against bacterial endospores.

8. The mechanism of activity of the composition should not give rise to resistance.

9. The composition should be of low toxicity to non-target life forms.

10. The composition should be adequately stable to allow ease of use and storage.

11. The composition should be simple to use.

12. The effect and residue chemistry of the composition should be environmentally benign.

13. The composition should remain rapidly effective down to low temperatures of around 4° C. or lower.

14. The composition should embody an indicator of its performance.

15. The composition should be cost effective in use.

To produce an antimicrobial composition with all of these properties is extremely difficult as such products, by their nature, are toxic and reactive. Many are comprised of complex organic molecules, the residues of which resist environmental breakdown or may bio-accumulate. Others react with organic matter and may be knocked out in the presence of high soil levels or may react with organic soil to produce toxic or carcinogenic compounds. Many are unstable or of limited spectrum.

### BRIEF SUMMARY OF THE INVENTION

It is an object of the present invention to provide a construction comprising a substrate incorporating with an activatable antimicrobial composition which exhibits most and, in specific formulations, all of the aforementioned properties. Such a substrate must retain the antimicrobial composition in a stable manner ready for use, at which time the composition can be activated, for example by wetting the substrate with water or other appropriate liquid.

### DETAILED DESCRIPTION OF THE INVENTION

According to the present invention there is provided a construction comprising a substrate incorporating an activatable antimicrobial composition that includes a peroxygen donor and at least one of an acid and an acid-producing substance, the peroxygen donor being incorporated separately and in a different portion of the substrate from the other component or components of the composition.

In such a construction, the peroxygen donor is incorporated separately and in a different portion of the substrate from the other components of the composition in order that the antimicrobial composition is only formed and activated once the substrate is wetted, preferably with water.

Advantageously, the substrate is constructed as a laminate, such as a nonwoven laminate, comprising layers bonded together by a bonding medium which may be applied as a powder, net or sheet, the peroxygen donor being incorporated in the substrate in between different layers from the other components, or otherwise separated by application in a different zone or area of the substrate, for instance in parallel scatterings or in different parts of a scatter pattern.

Preferably also, the substrate comprises a nonwoven material made from cellulosic fibers, for example cotton, viscose, regenerated wood pulp cellulose or similar material. Alternatively or in addition, the material comprises fibers including at least one of polyester, polyamide, polyethylene, and polypropylene fibers. Where the fibers of the nonwoven have physical properties, for example bi-component fibers, which allow the substrate to be thermally or physically bonded or entangled in a discreet layer or web, it may be possible to dispense with all or most of the bonding medium.

Preferably also, the substrate is impregnated with an oxygen-sensitive dye, such as a vat dye, which acts to indicate activity of the antimicrobial composition.

Preferably also, the acid comprises a carboxylic acid.

In some embodiments, the antimicrobial composition additionally incorporates an organometallic manganese containing catalyst, for example a manganese-trimethyltriazacyclononane complex.

Preferably also, the acid may comprise abidentate acid and preferably oxalic acid. Such acids can influence the nuclearity and redox potential of the metal centers in the catalyst which, in turn, improves the spectrum and speed of biocidal activity. Alternatively, however, other acids such as fumaric, ascorbic, succinic, glutaric and mixtures thereof may also be used. In addition, combinations of acid and salts of the acid may also be used, for instance, oxalic acid and sodium oxalate. A combination of oxalic acid and pH buffers such as sodium phosphate may also be used.

Combinations of acids may also be used, for example a combination of oxalic acid and citric acid. Also, reaction between the peroxygen donor and a bleach activator, such as tetra acetyl ethylene diamine (TEED) would beneficially produce per acetic acid. Such a reaction will occur on activation of the composition. Hence, advantageously, the acid of the composition may be a separate component of the composition or may be generated in situ in the substrate on activation.

The peroxygen donor may be chosen from any of those compounds exhibiting strong redox potential by generation of hydrogen peroxide or other mechanism. Preferably, therefore, the peroxygen donor comprises any of sodium perborate as mono or tetra hydrate, sodium percarbonate, and sodium persulphate. It is also possible to generate an effective composition in situ by activating the substrate using a hydrogen peroxide solution.

In order to most completely meet the above list of desirable properties, rapidly at low temperatures, in particular at temperatures below 4° C., the substrate is preferably additionally incorporates the aforesaid organometallic manganese containing catalyst. Advantageously, the organometallic manganese containing catalyst comprises a manganese-trimethyltriazacyclononane complex, such as that known commercially as catalyst NP 1033, CAS No 116633-52-4. This is a manganese compound of the ligand 1,4,7-trimethyl-1,4,7-triazacyclononane. However, other manganese catalysts with related ligand structures and other biomimetic manganese containing catalysts may also be used.

The catalyst to peroxygen donor ratio may be as high as 1:100000, however, preferably, the preferred ratio is between 1:100 and 1:3000 inclusive.

Likewise, the catalyst to acid ratio, preferably when using bidentate carboxylic acid, can be in the range 1:1 to 1:100 but preferably the preferred ratio is between 1:3 and 1:50 inclusive.

Other components may usefully be added to the composition according to the invention. These may comprise one or more of anionic or nonionic surfactants such as sodium lauryl sulphate or linear alcohol ethoxylates; corrosion inhibitors, pH buffers, chelating agents or sequestrants, stabilizers, dyes, fragrances and odor masking agents.

Two examples of formulations of antimicrobial compositions in accordance with the invention will now be described.

### EXAMPLE 1

| | | |
|---|---|---|
| Sodium perborate tetrahydrate | 1.05 | parts |
| Tetra acetyl ethylene diamine | 0.014 | parts |
| Oxalic acid | 0.35 | parts |
| NP 1033 | 0.01 | parts |

### EXAMPLE 2

| | | |
|---|---|---|
| Sodium percarbonate | 50 | parts |
| Tetra acetyl ethylene diamine | 25 | parts |
| Sequestrant | 2 | parts |
| Anionic surfactant | 5 | parts |
| Citric acid | 1 | part |

The antimicrobial performance of each these formulations can be demonstrated by adding 1 part formulation to 10 parts of water. The ensuing solutions both meet the requirements of the European suspension test EN1276:1997. This test is a quantitative suspension test for the evaluation of bactericidal activity of chemical disinfectants and antiseptics used in foods, industrial, domestic and institutional areas. To meet the test a greater than log 5 kill of all test organisms must occur within a 5 minute contact time and at temperatures of both 20° C. and 4° C. in both clean and dirty conditions. The test organisms used are Pseudomonas aeruginosa, Escherichia coli, Staphylococcus aureus and Enterococcus hirae.

Both of the formulations also show excellent sporicidal, fungicidal and virucidal properties in standard tests. In addition, it should be noted that the residue products of Example 1 are environmentally benign. It is known that in formulations containing peroxygen donors and bleach activators such as TAED that a very wide range of ratios of the two components can be used determined by requirements such as the concentration of peracetic acid generated, the rate of generation, the pH of the system, the stability, solubility and other factors. Hence in constructions in accordance with this invention a wide range of ratios of the antimicrobial composition and quantitative loadings of the substrate is possible.

An additional formulation of antimicrobial composition in accordance with the invention will now be described.

### EXAMPLE 3

| | |
|---|---|
| Sodium perborate tetrahydrate | 1.05 parts |
| Oxalic acid | 0.35 parts |
| NP 1033 | 0.01 parts |

This formulation excludes the bleach accelerator. It also passes the European suspension test EN1276:1997 for all test organisms at a temperature of 20° C. but not at a temperature of 4° C. Hence although useful, it may have more limited applications than other formulations of the composition.

A change in the oxidation state of the manganese catalyst where used in these formulations is also accompanied by a colour change. These formulations therefore embody an indicator of their performance.

The components of the antimicrobial composition are preferably produced in the form of powders or granules for ease of incorporation into separate portions of the body of the substrate, as described above, in order that the construction can remain in a stable condition ready for use. At this time, the antimicrobial composition can be activated by wetting the substrate with water. Such wetting may occur when a wipe construction according to the invention is wetted or is used to wipe a wet or damp surface; or is used to absorb a spillage containing an aqueous component; or is used as a filter for water which may be contaminated; or is moistened by water vapour, perspiration or other means.

Three embodiments of construction in accordance with the present invention are as follows.

### Embodiment 1

The substrate comprises a nonwoven laminate construction comprising two layers of hydroentangled nonwoven containing viscose and polyester fibres separated by a thermoplastic bonding medium in sheet form. The layer between the bottom nonwoven and the bonding medium contains the peroxygen donor. The layer between the bonding medium and the top nonwoven contains the tetra acetyl ethylene diamine, surfactant, acid and other components of the antimicrobial composition. The chemical components of the formulation being present at quantitative levels and in such ratios and at such a pH as to generate levels of peracetic acid when the substrate is wetted, which levels of peracetic acid are appropriate to the biocidal task required.

### Embodiment 2

The substrate comprises a nonwoven laminate construction as described above in Embodiment 1 but wherein the bonding medium is a low melting point thermoplastic powder and the peroxygen donor component of the formulation is separated from the other components by virtue of being applied by scattering or other means which ensure the peroxygen donor powder is restricted to areas of the substrate not covered by other components with which it might react.

### Embodiment 3

The substrate comprises a nonwoven laminate construction made up of highly absorbent airlaid fibers as one of the nonwoven layers, in which the peroxygen donor is sodium perborate monohydrate present at 15 g per square meter. The other components of the antimicrobial composition, which include TAED present at 8.0 g per square meter, are separated by virtue of two discreet patterns of powder scattering in combination with a thermoplastic powder bonding adhesive. The complete construction, on wetting, is capable of generating 500 ppm of peracetic acid in one liter of water.

1. A construction comprising:
an activatable antimicrobial composition being comprised of a peroxygen donor and at least one of an acid and an acid-producing substance; and
a substrate comprising a laminate having at least two layers bonded together by a thermoplastic bonding medium, said substrate incorporating said activatable antimicrobial composition, said peroxygen donor being incorporated in said laminate and being retained separate from other component or components of the composition by said thermoplastic bonding medium.

2. A construction as claimed in claim 1, wherein said peroxygen donor is incorporated and retained between different layers of said laminate than the other components of the composition by said thermoplastic bonding medium, the bonding medium being in sheet form.

3. A construction as claimed in claim 1, wherein said peroxygen donor is separated from the other components of the composition by application and retention of said peroxygen donor in a different zone of said substrate by said thermoplastic bonding medium.

4. A construction as claimed in of claim 1, wherein said substrate comprises a nonwoven material formed by at least one of cellulosic fibers, polyester fibers, polyamide fibers, polyethylene fibers, and polypropylene fibers.

5. A construction as claimed in claim 1, wherein said laminate comprises at least two layers bonded together by the thermoplastic bonding medium, the bonding medium being applied as a powder, net or sheet prior to a bonding process.

6. A construction as claimed in of claim 1, wherein said peroxygen donor is in powder form and is retained separate from the other component or components of the composition by powder scattering in combination with a thermoplastic powder bonding medium.

7. A construction as claimed in claim 1, wherein said substrate is impregnated with an oxygen-sensitive dye, acting to indicate activity of the antimicrobial composition.

8. A construction as claimed in claim 1, wherein said acid comprises a carboxylic acid.

9. A construction as claimed in claim 1, wherein said acid comprises at least one of a bidentate acid, oxalic acid, fumaric acid, ascorbic acid, succinic acid, glutaric acid and any mixture thereof.

10. A construction as claimed in claim 1, wherein said acid comprises a mixture of an acid and a salt.

11. A construction as claimed in claim 1, wherein said acid-producing substance comprises a bleach activator.

12. A construction as claimed in claim 11, wherein said bleach activator comprises tetra acetyl ethylene diamine.

13. A construction as claimed in claims 1, wherein said peroxygen donor comprises at least one of sodium perborate as mono or tetra hydrate, sodium percarbonate, and sodium persulphate.

14. A construction as claimed in any of claim 1, wherein the antimicrobial composition further comprises an organometallic manganese containing catalyst.

15. A construction as claimed in claim 14, wherein said organometallic manganese containing catalyst comprises a manganese-trimethyltriazacyclononane complex.

16. A construction as claimed in claim 14, wherein said catalyst has a catalyst to peroxygen donor ratio in a range between 1:100 and 1:3000 inclusive.

17. A construction as claimed in claim 14, wherein said catalyst has a catalyst to acid ratio in a range between 1:3 and 1:50 inclusive.

18. A construction as claimed in claim 1, further comprising:
one or more additives selected from a group consisting of surfactants, corrosion inhibitors, pH buffers, sequestrants, stabilizers, dyes, fragrances, odor masking agents, and mixtures thereof.

19. A construction as claimed in claim 1, wherein said activatable antimicrobial composition is formulated in accordance with any one of Examples 1 to 3 as follows:
Example 1

| | | |
|---|---|---|
| Sodium perborate tetrahydrate | 1.05 | parts |
| Tetra acetyl ethylene diamine | 0.014 | parts |
| Oxalic acid | 0.35 | parts |
| NP 1033 | 0.01 | parts |

Example 2

| | | |
|---|---|---|
| Sodium percarbonate | 50 | parts |
| Tetra acetyl ethylene diamine | 25 | parts |
| Sequestrant | 2 | parts |
| Anionic surfactant | 5 | parts |
| Citric acid | 1 | part |

Example 3

| | |
|---|---|
| Sodium perborate tetrahydrate | 1.05 parts |
| Oxalic acid | 0.35 parts |
| NP 1033 | 0.01 parts |

20. (canceled)
